(19) United States
(12) Patent Application Publication
(10) Pub. No.: US 2022/0149779 A1
(43) Pub. Date: May 12, 2022

(54) Folding lightweight solar panel

(71) Applicant: Zhixiang Zhang, Heyuan (CN)

(72) Inventor: Zhixiang Zhang, Heyuan (CN)

(21) Appl. No.: 17/648,938

(22) Filed: Jan. 26, 2022

(51) Int. Cl. H02S 30/20; H02S 20/30

(52) U.S. Cl. CPC H02S 30/20; H02S 20/30

(57) ABSTRACT

A folding solar panel includes two solar modules, two support legs and a connection mechanism. Each support leg includes a main body pivotably secured to the solar module using the connection mechanism, a strap having a first end attached to the main body, and a length adjustment member moveably disposed on of the main body for adjusting length of the strap, thereby adjusting an angle of each of the solar modules with respect to the ground.

### FIELD OF THE INVENTION

The invention relates to solar panels and more particularly to a folding lightweight solar panel.

### BACKGROUND OF THE INVENTION

A solar cell, or photovoltaic cell, is an electrical device that converts the energy of light directly into electricity by the photovoltaic effect. A solar panel is an assembly of solar cells mounted in an inclined framework for installation. However, the conventional framework has the disadvantages including being difficult to assemble or disassemble the framework, being time consuming in the assembling or disassembling process, and being difficult to adjust the inclined angle of the framework (i.e., the solar panel).

Thus, the need for improvement still exists.

### SUMMARY OF THE INVENTION

The invention has been made in an effort to solve the problems of the conventional art by providing a folding lightweight solar panel having novel and nonobvious characteristics.

To achieve above and other objects of the invention, the invention provides a folding solar panel comprising two solar modules, two support legs, and a connection mechanism on backs of the solar modules, wherein each of the support legs include a main body formed of aluminum alloy and pivotably secured to the solar module by means of the connection mechanism, a strap having a first end attached to the main body, and a length adjustment member moveably disposed on the main body for adjusting length of the strap, thereby adjusting an angle of each of the solar modules with respect to the ground.

Preferably, each of the solar modules include a plurality of clasps for mounting both the connection mechanism and the straps on the back of the solar module, and wherein the solar module is inclined at an angle between 30 degrees and 60 degrees with respect to the ground.

Preferably, the connection mechanism is mounted on backs of the solar modules by means of the clasps.

Preferably, the support leg further comprises a plurality of rulers disposed on the strap, each of the rulers having a plurality of angle marks, and wherein a value of the ruler is obtained by calculating a distance of the length adjustment member moving on the main body and an inclined angle of the main body with respect to the solar module.

Preferably, the two support legs are joined pivotably, and wherein one of the solar modules further comprises a pocket provided on the back.

Preferably, the connection mechanism includes a plurality of pipes made of aluminum alloy, a strap made of nylon and passing through the pipes, and a fastening member at a first end of each of the pipes; and wherein the fastening members are configured to join to straighten the connection mechanism.

Preferably, the support leg further comprises a tubular plastic member at a first end of the main body and configured to put on the pipe, and an anti-skid member disposed at a second end of the main body and rested on the ground.

Preferably, the support leg further comprises a plastic buckle at a second end of the strap, the buckle configured to attach to one of the clasps.

Preferably, the first end of the strap passes through the tension adjustment member to attach to the anti-skid member.

Preferably, each of the solar modules further comprise a handle on the back, the handle being trapezoidal and including a cavity.

The folding lightweight solar panel of the invention has the following advantageous effects in comparison with the prior art:

The installation or separation of the support legs and the solar modules is made easy due to the provision of the detachable connection mechanism. An inclined angle of the solar module with respect to the ground can be easily adjusted by means of the strap and the tension adjustment member.

The pocket can store the separated support legs and the connection mechanism. Portion of the support legs and the connection mechanism are made of aluminum alloy having sufficient strength and decreased weight, thereby facilitating the transport.

The above and other objects, features and advantages of the invention will become apparent from the following detailed description taken with the accompanying drawings

### BRIEF DESCRIPTION OF THE DRAWINGS

FIG. 1 is a perspective view of a folding lightweight solar panel of the invention;

FIG. 2 is perspective view of the solar module;

FIG. 3 is a perspective view of the support leg; and

FIG. 4 is a perspective view of the connection mechanism in a storage state.

### DETAILED DESCRIPTION OF THE INVENTION

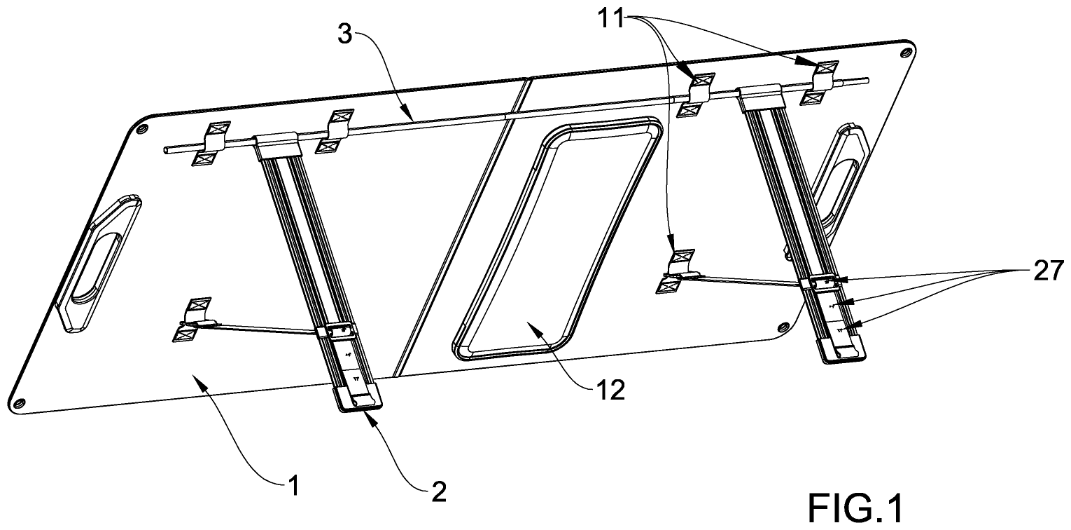

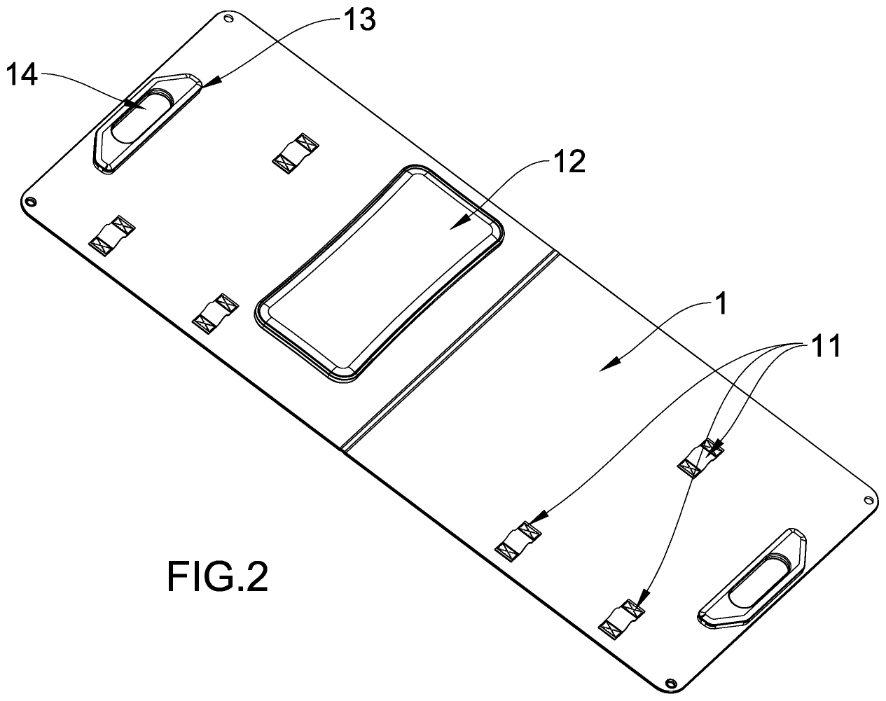

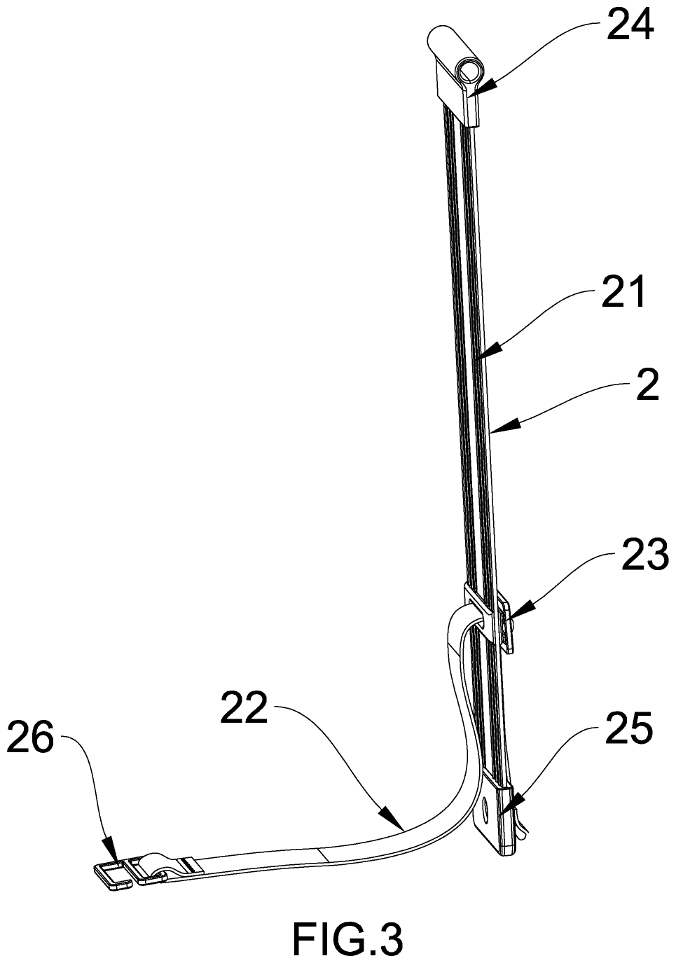

Referring to FIGS. 1 to 4, a folding lightweight solar panel in accordance with the invention comprises two solar modules 1, two support legs 2 and a connection mechanism 3 as discussed in detail below.

The support leg 2 includes a main body 21 formed of aluminum alloy and pivotably secured to the solar module 1 by means of the connection mechanism 3, a strap 22 having one end attached to the main body 21, and a length adjustment member 25 at an open end of the main body 21 for adjusting length of the strap 22.

The solar module 1 includes a plurality of clasps 11 for mounting both the connection mechanism 3 and the straps 22 on the back of the solar module 1, Preferably, the solar module 1 is inclined at an angle between 30 degrees and 60 degrees to maximize use sunlight as a source of energy to generate direct current electricity. The clasp 11 is implemented as a nylon fabric which is advantageous due to wear-proof and lightweight. As such, it is easy to move the solar module 1. A removal of the connection mechanism 3 out of the clasps 11 may disassemble the solar module 1, the support legs 2 and the connection mechanism 3.

As shown, the number of the solar module 1 is two. The connection mechanism 3 is mounted on the backs of the two solar modules 1 by means of the clasps 11. After assembly, one solar module 1 is not capable of pivoting about the other solar module 1. As a result, stability of the invention is increased.

The support leg 2 further comprises a plurality of rulers 27 having a plurality of angle marks provided on the strap 22. A value of the ruler 27 can be obtained by calculating a distance of the length adjustment member 25 moving on the main body 21 and an inclined angle of the main body 21 with respect to the solar module 1. After the length adjustment member 25 has been moved to a position proximate a plastic member 24 at the other end of the main body 21, one end of the main body 21 is adhesively secured to the clasp 11 which is used to hold the strap 22 in place. A movement of the strap 22 on the main body 21 changes an angle of the main body 21 with respect to the solar module 1. Thus, the value of the ruler 27 can be obtained, thereby facilitating the adjustment of a pivotal angle of the solar module 1 with respect to the main body 21.

The two support legs 2 are joined pivotably by means of, for example nylon so that one solar module 1 may be pivoted to rest on the back of the other support leg 2 for the sakes of saving storage space and transporting. One of the solar modules 1 further comprises a pocket 12 provided on the back for storing the separated support legs 2 and the connection mechanism 3.

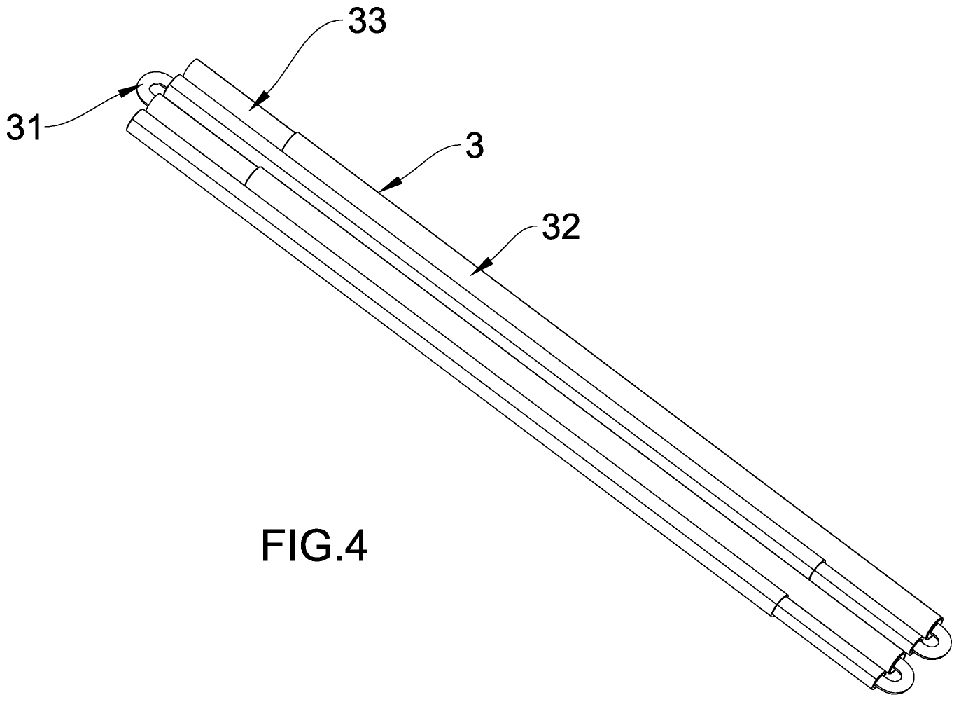

The connection mechanism 3 includes a plurality of (two) pipes 32 made of aluminum alloy, a strap 31 made of nylon and passing through the pipes 32, and a fastening member 33 at an end of each pipe 32. The fastening members 33 are configured to join to straighten the connection mechanism 3 at the backs of the two solar modules 1 (see FIG. 1). The number of the pipes 32 and the strap 31 may increase if more than two solar modules 1 are joined. As shown in FIG. 4 specifically, the pipes 32 are joined as a straight line and an end of the strap 31 is knotted to be tightened in a state of use. To the contrary, the knot at the end of the strap 31 should be unknotted prior to disassembling the pipes 32.

The tubular plastic member 24 is provided at one end of the main body 21 and is configured to put on the pipe 32. An anti-skid member 25 is provided at the other end of the main body 21 and rested on the ground. The plastic member 24 is lightweight and strong and facilitates the portability of the invention.

One end of the strap 22 is provided with a buckle 26 made of plastic. The buckle 26 is configured to attach to one of the clasps 11 so that the engagement or disengagement of the strap 22 and the clasp 11 is made easy.

The other end of the strap 22 passes through a tension adjustment member 23 on the main body 21 to attach to the anti-skid member 25. A handle 13 is provided on the back of the solar module 1. The handle 13 is trapezoidal and includes a cavity 13 to be grasped by the hand. A person can grasp the handles 13 to carry the folded solar modules 1.

It is envisaged by the invention that the installation or separation of the support legs 2 and the solar modules 1 is made easy due to the provision of the detachable connection mechanism 3. An inclined angle of the solar module 1 with respect to the ground can be easily adjusted by means of the strap 22 and the tension adjustment member 23.

While the invention has been described in terms of preferred embodiments, those skilled in the art will recognize that the invention can be practiced with modifications within the spirit and scope of the appended claims.

What is claimed is:

1. A folding solar panel, comprising two solar modules, two support legs, and a connection mechanism on backs of the solar modules, wherein each of the support legs include a main body formed of aluminum alloy and pivotably secured to the solar module by means of the connection mechanism, a strap having a first end attached to the main body, and a length adjustment member moveably disposed on the main body for adjusting length of the strap, thereby adjusting an angle of each of the solar modules with respect to the ground.

2. The folding solar panel of claim 1, wherein each of the solar modules include a plurality of clasps for mounting both the connection mechanism and the straps on the back of the solar module, and wherein the solar module is inclined at an angle between 30 degrees and 60 degrees with respect to the ground.

3. The folding solar panel of claim 1, wherein the connection mechanism is mounted on backs of the solar modules by means of the clasps.

4. The folding solar panel of claim 1, wherein the support leg further comprises a plurality of rulers disposed on the strap, each of the rulers having a plurality of angle marks, and wherein a value of the ruler is obtained by calculating a distance of the length adjustment member moving on the main body and an inclined angle of the main body with respect to the solar module.

5. The folding solar panel of claim 1, wherein the two support legs are joined pivotably, and wherein one of the solar modules further comprises a pocket provided on the back.

6. The folding solar panel of claim 1, wherein the connection mechanism includes a plurality of pipes made of aluminum alloy, a strap made of nylon and passing through the pipes, and a fastening member at a first end of each of the pipes; and wherein the fastening members are configured to join to straighten the connection mechanism.

7. The folding solar panel of claim 1, wherein the support leg further comprises a tubular plastic member at a first end of the main body and configured to put on the pipe, and an anti-skid member disposed at a second end of the main body and rested on the ground.

8. The folding solar panel of claim 1, wherein the support leg further comprises a plastic buckle at a second end of the strap, the buckle configured to attach to one of the clasps.

9. The folding solar panel of claim 1, wherein the first end of the strap passes through the tension adjustment member to attach to the anti-skid member.

10. The folding solar panel of claim 2, wherein each of the solar modules further comprise a handle on the back, the handle being trapezoidal and including a cavity.
